(19) United States
(12) Patent Application Publication
(10) Pub. No.: US 2019/0066246 A1
(43) Pub. Date: Feb. 28, 2019

(54) INFORMATION MANAGEMENT AND ASSESSMENT SYSTEM FOR POLITICAL AND OTHER TYPES OF CANDIDATES

(71) Applicant: ADLER GUERRA DAVID, Montes Claros (BR)

(72) Inventor: ADLER GUERRA DAVID, Montes Claros (BR)

(21) Appl. No.: 15/691,793

(22) Filed: Aug. 31, 2017

(51) Int. Cl. G06Q 50/26; G06Q 20/10; G06Q 30/06; G07C 13/00; G06F 17/30

(52) U.S. Cl. CPC G06Q 50/26; G06Q 20/10; G06F 17/30979; G07C 13/00; G06Q 30/0641

(57) ABSTRACT

Fields of Application
Assessment of public figures profiles;
Interaction between society and political candidates;

This patent refers to a software program preferably applicable in countries that have a democratic political regime and aims to stimulate the participation of a new candidate profile for elections based on the political capability and moral suitability acquired within the society in which the candidate lives.

The basic concept underlying the development of this software is that people who are better capable, politically and morally, and not exclusively immersed in politics are less prone to corruption and, furthermore, it proposes to create a cleaner environment in which there is no room for permissive advertising.

Brief System Description Object of this Invention

The purpose of this software is to seek out, bring in, and qualify available individuals to run for public positions that are filled by means of direct elections, informing voters about the political capacity of each one, the position they wish to hold, and virtual, real-time voter approval ratings—virtual users on the portal—the candidates resumes linked to their portal will also be assessed by rules laid out by the portal itself, creating an automatic virtual approval rating from the system itself.

The initial access area is a portal with several virtual tools that allow the candidates' profiles to be seen and users to assess their moral concept, with search tools for the candidate most voted in the general assessment, best assessed by the system itself or its users, and best qualified based on their resumes, among other parameters.

### FIELDS OF APPLICATION

Assessment of public figures profiles;
Interaction between society and political candidates;

This patent refers to a software program preferably applicable in countries that have a democratic political regime and aims to stimulate the participation of a new candidate profile for elections based on the political capability and moral suitability acquired within the society in which the candidate lives.

The basic concept underlying the development of this software is that people who are better capable, politically and morally, and not exclusively immersed in politics are less prone to corruption and, furthermore, it proposes to create a cleaner environment in which there is no room for permissive advertising.

### Foundations of the Invention

The software, object of this invention, initially arose due to a deep questioning of the current political problems seen every day in the media, as well as from the devastating consequences mismanagement has caused to Brazilian society as a result of lapses in character, especially as related to systemic corruption, the absence of intellectual preparation to hold public office and, finally, the evident bankruptcy of party ideologies. Thus, a common point would be created through which the interests of the right, left, and center wings could be met and extremism avoided.

Furthermore, the system aims, among other things, to convince intellectually competent citizens with a good reputation to place themselves at the service of the local community, or of the country, according to the political office in question, in order to obstruct those who were elected on the basis of personal charisma, promises, and vote buying; in short, by all sorts of shenanigans that are often practiced in the political arena.

In the course of carrying out research, no tools were found that allowed information and experiences to be exchanged so as to get a better understanding of the proposals and analyze election results.

What is known in this regard are the social networks, which only serve as a venue for venting, and, more often than not, discussions are based on the shallowest understanding of the political scene and users defend candidates backed only by every type of “guessing”.

This system can be applied in any democratic country.

### BRIEF SYSTEM DESCRIPTION OBJECT OF THIS INVENTION

The purpose of this software is to seek out, bring in, and qualify available individuals to run for public positions that are filled by means of direct elections, informing voters about the political capacity of each one, the position they wish to hold, and virtual, real-time voter approval ratings—virtual users on the portal—the candidates resumes linked to their portal will also be assessed by rules laid out by the portal itself, creating an automatic virtual approval rating from the system itself.

The initial access area is a portal with several virtual tools that allow the candidates' profiles to be seen and users to assess their moral concept, with search tools for the candidate most voted in the general assessment, best assessed by the system itself or its users, and best qualified based on their resumes, among other parameters

It further proposes to:
1. Enable the user to also have his or her profile assessed by other users, making them a potential candidate for future elections or giving their comments more credibility during the ongoing exchange of information and political experiences.
2. Promote users' political capabilities, advocating courses in areas related to public administration as a way to boost the level of those who hold public office by virtue of elections.
3. Bring the candidates closer to the voter through media that is free of strong and emotional propaganda, or those that allow for the ridiculousness of politics. The user gets to know what the candidate has to offer to the voter, with room for questions and discussion forums, while on the lookout for political moralization.
4. Allow all candidates to promote their campaign proposals and present their resumes to portal users.
5. To promote a continual checking of profiles and moderation so as to avoid the possibility of false profiles or low level debates and penalizing them, as the case may be, by suspending or removing the profile and filing a complaint with the Federal Police, the Federal Prosecutor's Office, and the Superior Electoral Court.
6. Promote freedom of speech with respect, obstructing discriminatory acts as to race, religion, gender, party ideology, or any other nature, including filters to block the use of offensive and uncouth language.
7. Develop enrichment studies for the public manager and guidelines that could contribute to the performance of administrative or managerial acts.
8. Conduct public activism polls that could eventually result in the creation of popular initiative bills.
9. Assess candidate and user profiles and allow all users to assess the profiles among themselves.
10. Compile and divulge any public information that discredits the candidates.
11. Create a virtual memory so that users will always know what changes have been made to their candidate's profile and the reasons that led him or her to vote for one or another candidate, with space for user's vote justification, which may or may not be shared, at the user's discretion, so that in an upcoming election, how the candidate lives up to his or her campaign promises can be assessed and tracked whether the vote will be maintained or cast in favor of another candidate.
12. Educate users on election law and how the executive and legislative powers work at different levels.
13. Help candidates promote their profiles based on an analytical check of the areas of the map where they have a more or less higher concentration of voters.
14. Identify all companies supporting this project through certification seals and all candidates with significant system and user approval.
15. Provide for the signing of popular initiative bills in a simple, effective way.
16. Support the development of ideas and new projects aimed at eliminating corruption and ushering in quality public administration with the proper allocation of public funds.

### BRIEF DESCRIPTION OF THE DRAWINGS

FIG. 1 is a diagram of the LOGIN PAGE/REGISTRATION;

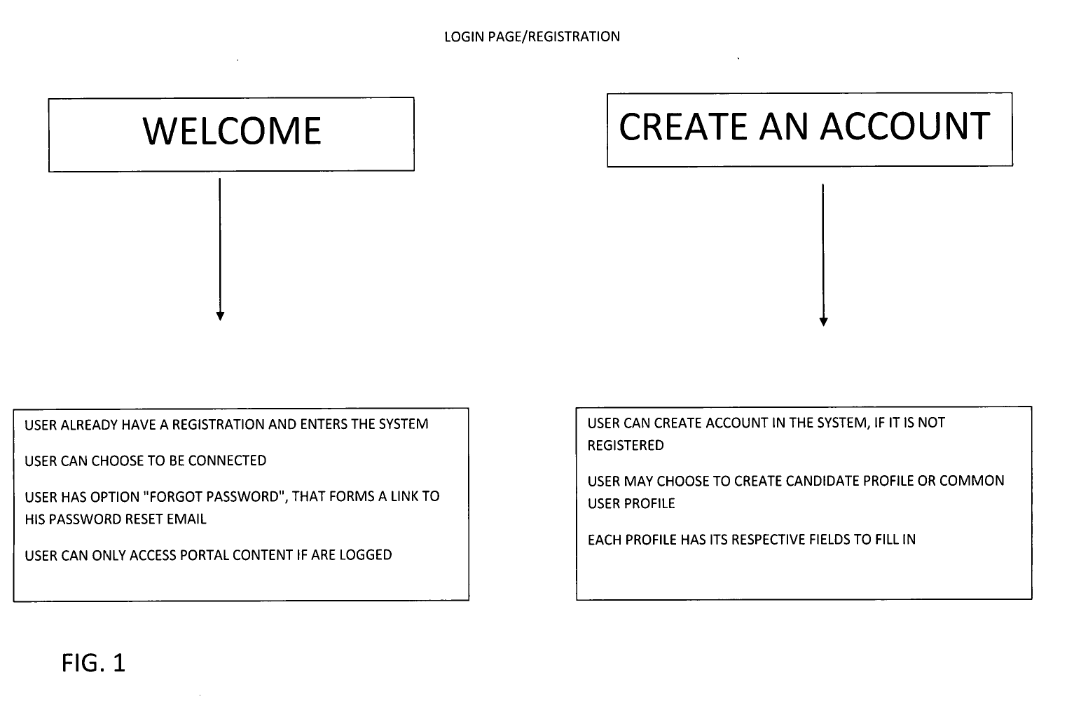

FIG. 2 is a diagram of the COMMON USER PROFILE PAGE;

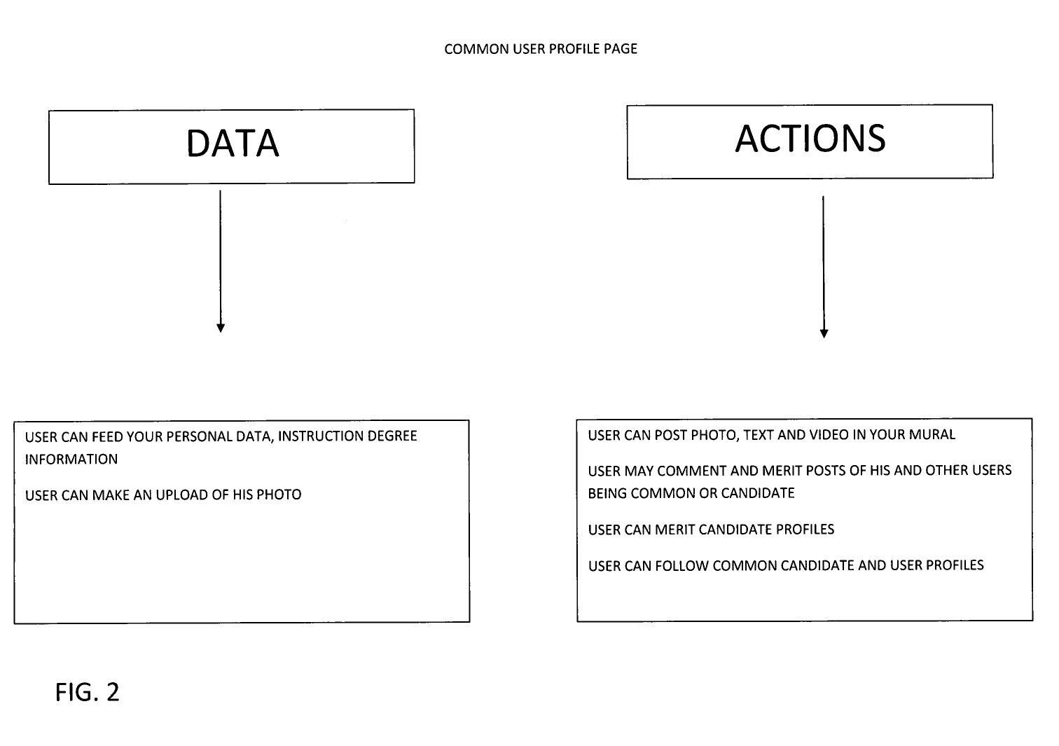

FIG. 3 is a diagram of the CANDIDATE PROFILE PAGE;

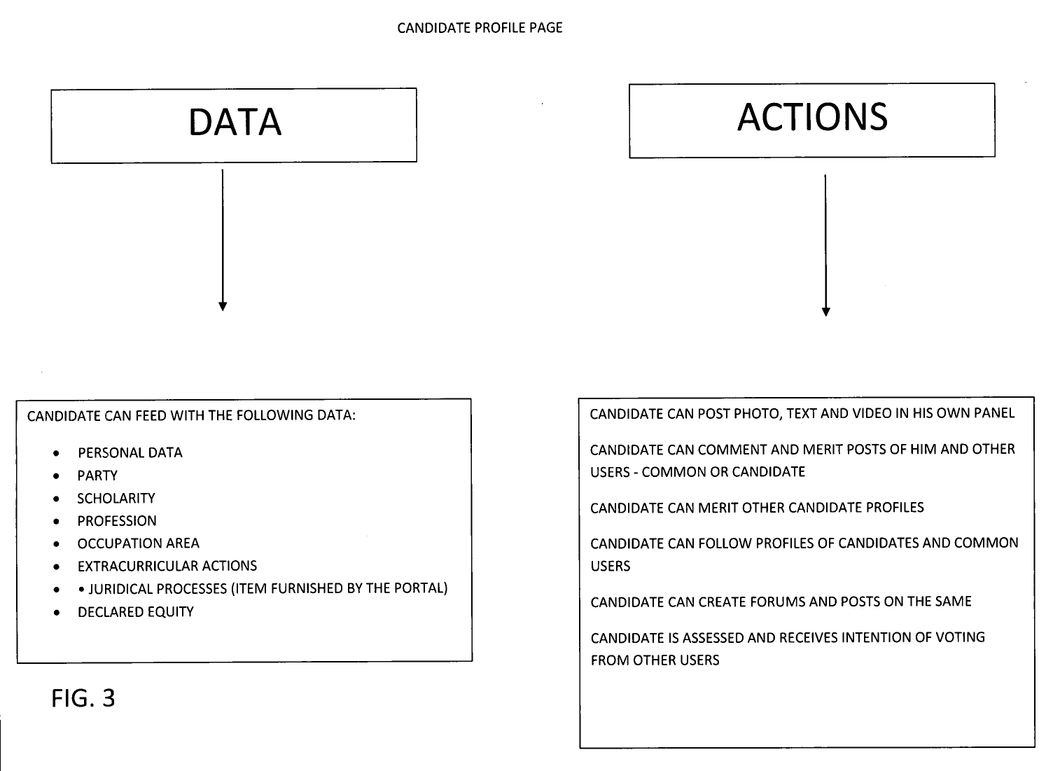

FIG. 4 is a diagram of the INSTITUTIONAL PAGES;

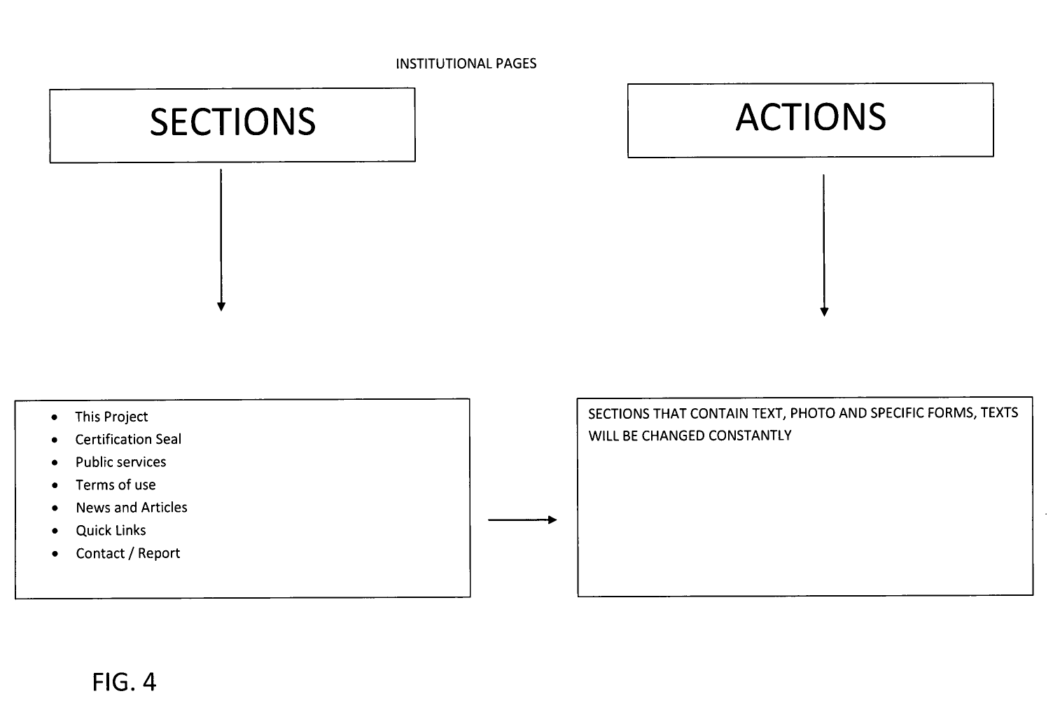

FIG. 5 is a diagram of the LAW PROJECTS PAGE;

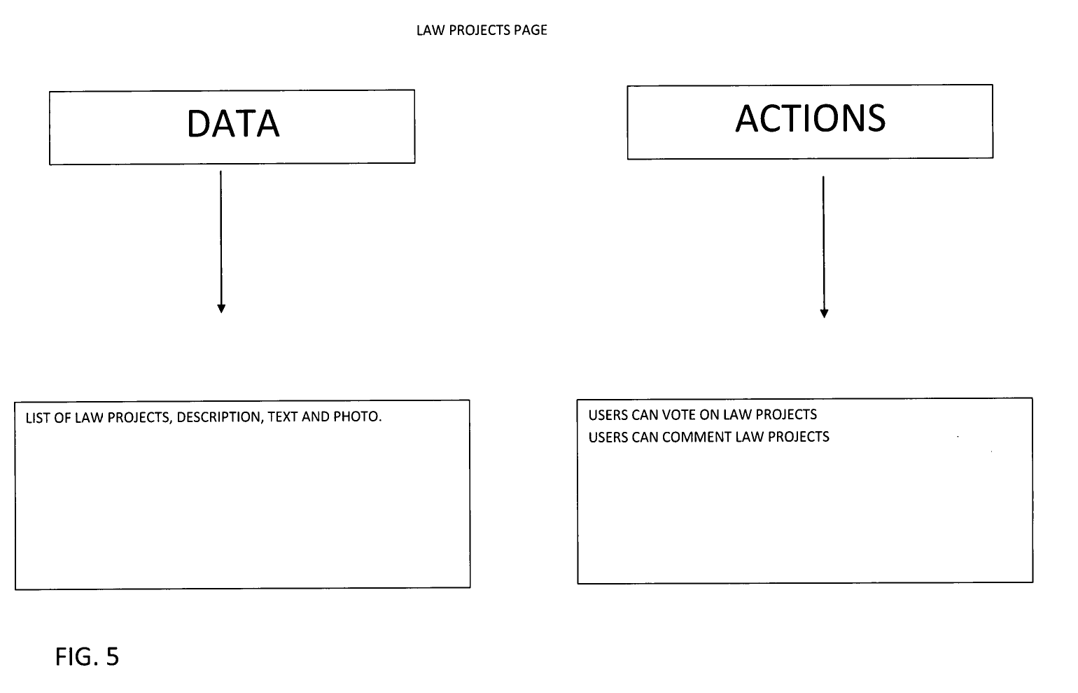

FIG. 6 is a diagram of the SHOPPING PAGE (MINI VIRTUAL SHOP);

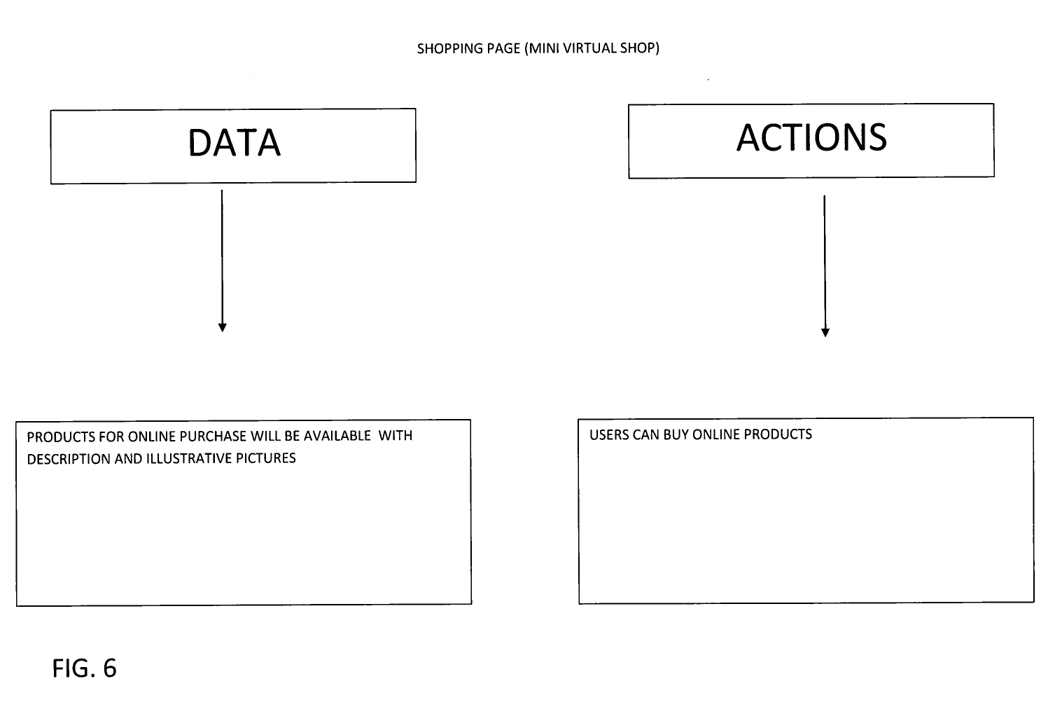

FIG. 7 is a diagram of the DISTANCE LEARNING PAGE (COURSES AND VIDEO CLASSES); and

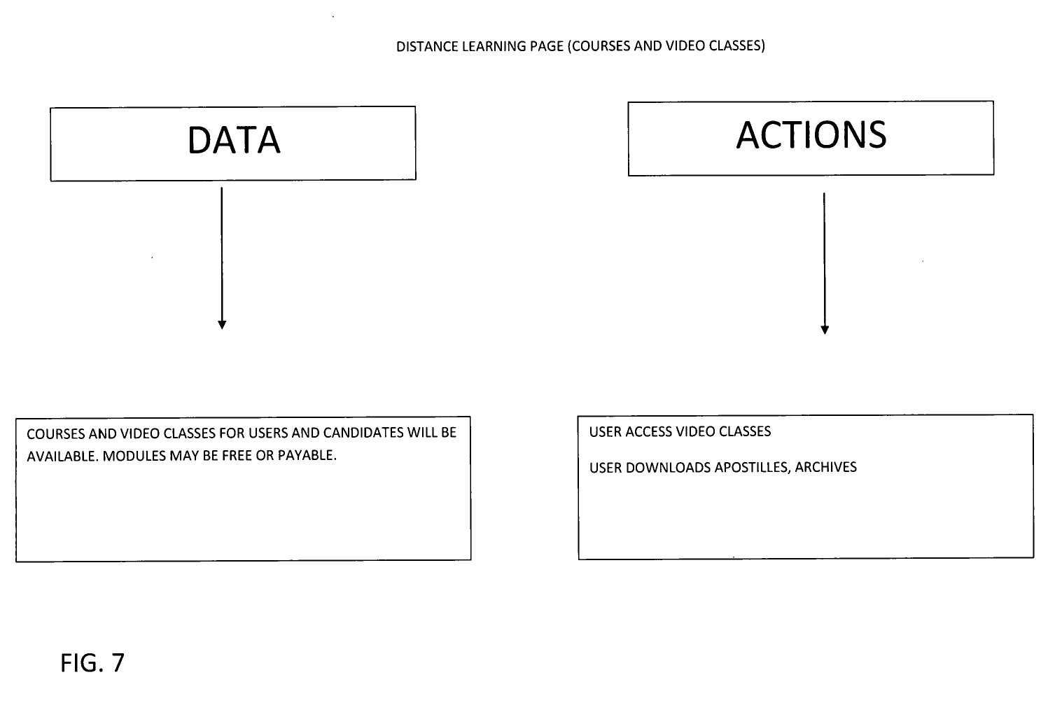

FIG. 8 is a diagram of the OFFICIAL ELECTION PAGE

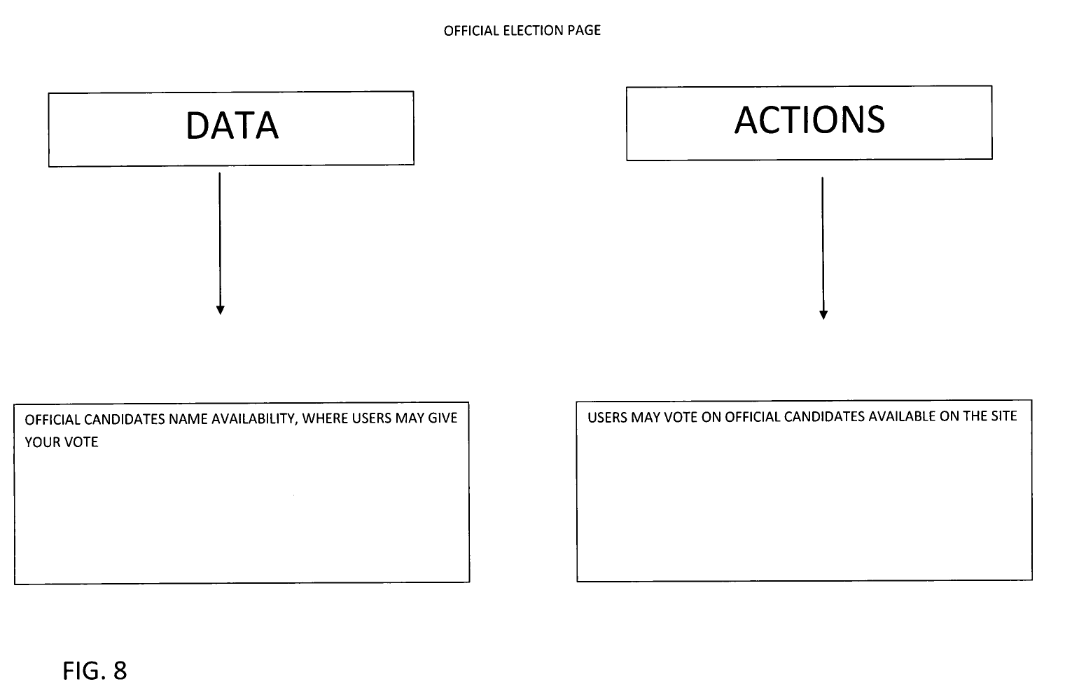

### DETAILED SYSTEM DESCRIPTION OBJECT OF THIS INVENTION

Final Product

Portal (social network) and app with the same content as the website, but installable on smartphones, tablets, and other mobile devices.

Strategic Position

The portal's security requirements and functions will be rigorously maintained, as it may have thousands of accesses, so it is extremely important to use all possible tools to ensure such a large volume, preferably using SSL or similar tools.

### Description of Modules

The following sections and their functions will be developed for the portal:

### Home (Location Selection)

Choose the state and city and project video. A map of Brazil or the country object of the project will be assembled, with a filter for each state, region, district, etc. The map will preferably be developed in JavaScript.

### Home (Filters)

Candidates' queries will be filtered by Location, Area of Action, Candidate's Name, Resumes, Candidate Assessment by the System's Algorithm, Popular Assessment, Extracurricular Actions, Processes, Declared Assets, Number of Companies/Areas, and International Experience.

### Institutional

Who we are, The Project, Mission, Vision, section with text and photos.

### Candidate Profile

Section with list of candidates with texts, photos, and files referring to Location, Area of Action, Candidate's Name, Resumes, Candidate Assessment by the System's Algorithm, Popular Assessment, Extracurricular Actions, Processes, Declared Assets, Number of Companies/Areas, And International Experience.
VIDEO SECTION: Section for posting YouTube or Vimeo videos for each candidate (candidates will have an administrative area to manage their videos). The administrative area will have instructions on what constitutes inappropriate content for the meritus portal, subject to penalty.
FREE OF CHARGE PERIOD: A field and rules shall be added to the administrative area through which candidates will be informed of the period within which they'll be able to register at no charge (subject to change at any time by the administrator).
COLOR DIFFERENCE: Candidate's profile will have a different color from that of a member.
QUESTION SYSTEM: An intelligent system for registering questions and answer choices to be displayed during candidate registration. Such a measure will help the portal moderator make decisions according to the answers chosen. The system will include a report with statistical information pertaining to the answers. For example: For Question ‘X’, 60% checked ‘A’, 23% checked B, and so on.
DISPLAY OF VOTING INTENTIONS: The system will filter candidates with the best profile assessment, according to the rules set forth at the time the user or candidate profile is created, and show them in the order of the best voting intention approval ratings.
HIDE MENUS: The candidate may use the administrative panel to decide which ‘menu’ will be shown on his or her profile.
ASSESSMENT OF THE CANDIDATE OR HIS OR HER ACTIONS: An area similar to the online services will be included, like ‘complainhere.com’, where users may complain to the candidates and the candidates will be able to reply the complaint, and in the end, with the possibility of assessing the complaint.
FORUM: A forum will be included for interaction between the candidate and users.
MONITORING AND STATISTICAL DATA: A panel will be included with statistical data for each candidate profile. The number of accesses will be displayed, as well as which menus will be accessed in the profile, whether the user has informed his/her voting intention or not, positive and negative votes.

### Candidate Registration—Security

The registration form will have specific data provided by the contracting party for the candidate to register. The information must be identical to that which appears in the system's database, and the candidate's registration will only be completed and activated through a token sent to the e-mail that appears in system's database (a security measure to prevent fraud).

### Candidate's Area

After registration has been activated, the candidate will have access to the restricted area, with access to his or her information made available according to the rules defined by the portal, and may submit materials relating to his or her merits and resume so as to increase the score in the system's assessment.

### News

Section for posting news with text, photos, and videos.

### Articles—Books

Section for posting articles with text, photos, and videos.

### Public Services

There will be a guidance tool for those in public office as to how to proceed on certain issues. Draft bills and step-by-step guidelines for, but not limited to, carrying out bidding processes, and bidding documents. Practical suggestions that have already been used and proven to work well for other managers will also be included.

### Certification Seal

Section with text and photos, describing the criteria for getting the portal's “Certification Seal”.

### Terms of Use

Section with text and photos, including the portal's general rules.

### Front End Comments Module

Candidates' pages, news, and articles will have their own comments system, which will be published only after approval by the portal moderator.

### Popular Assessment

The popular assessment will be defined by scores and grades determined by the portal.

### Assessment by the System's Algorithm

Assessment will be defined by calculations on the submission of merits and resumes by the candidate.

### User Registration

The user registration form will have basic personal data. A registered user will have access to all portal contents, whereas an unregistered user will only see limited content.

### User Panel

Every contribution system will have a user panel with a login that allows users to follow intellectual, financial, and historical contributions.

### Receiving Candidate and User Contributions.

The portal will have the options of receiving via Paypal, Pagseguro, credit cards, or other similar methods with the amounts defined by the individual or legal entity registered in the Portal Administration, such amounts being donated freely and spontaneously.

Interaction with Facebook® and Other Social Networks

Options to enjoy and share the social networks made available to the system can be found on the news and articles pages and the candidate's internal page.

### Contact

Contact form, address, telephones, e-mails, map showing how to get there.

### Shopping Page

The Portal will have an integrated virtual store, where products will be registered by the Portal Administration, which will be available for making purchases with payment made with credit cards or other similar methods in separate accounts.

### Voting on Bills

A list of bills with text and photos will be available where each bill will have a vote button and users may register their votes by entering their CPF number.

### Distance Learning Course—Video Classes

Video classes and online course materials will be made available, where the user accesses the course and watches video lessons and downloads materials.

### Additional Functions

PAGE: City register (voter limiter)

A rule will be created in the register in which each city will have a maximum number of voters, so the system registers and calculates the maximum number of votes in each city, thus fully automating the amount of registrations of intentions to votes in each region.

PAGE: User profile

PROFILE: A user profile will be put together with personal data and photo.

PAGE: Quick links

COURSES: Picture and short description on the courses section, which will be developed later on.

CERTIFICATION SEAL: Picture and short description of the certification seal.

TURNING SOMEONE IN: Link to turn someone in—only one link will be provided for third-party websites.

SUPPORT TO THE MANAGER: Picture and short description of public manager support system.

ELECTORAL CODE: Link to electoral code—only one link will be provided to a third party site or made available by text or pdf file inside the portal.

PAGE: Videos

Section for posting YouTube, Vimeo, or other videos with an intelligent filter for keywords.

PAGE: Final virtual election

When election time arrives, legitimate candidates from each city, district, state, or country will be registered by the administrator, and users will be able to vote for only one candidate. The vote will be confidential for viewing in the portal and will only be seen by the user who voted.

1. INFORMATION MANAGEMENT AND ASSESSMENT SYSTEM FOR POLITICAL AND OTHER TYPES OF CANDIDATES, designed to seek out, bring in, and qualify available individuals to run for public positions that are filled by means of direct elections, informing voters about the political capacity of each one, the position they wish to hold, and virtual real-time voter approval ratings, characterized by enable the user to also have his or her profile assessed by other users, making them a potential candidate for future elections or giving their comments more credibility; promote users' political capabilities, advocating courses in areas related to public administration as a way to boost the level of those who hold public office by virtue of elections; allow all candidates to promote their campaign proposals and present their resumes to portal users; to promote a continual checking of profiles and moderation so as to avoid the possibility of false profiles or low level debates; promote freedom of speech with respect, obstructing discriminatory acts as to race, religion, gender, party ideology, or any other nature; develop enrichment studies for the public manager and guidelines that could contribute to the performance of administrative or managerial acts; conduct public activism polls that could eventually result in the creation of popular initiative bills; promote assessment of candidate and user profiles, allowing all users to assess the profiles among themselves; compile and divulge any public information that discredits the candidates; create a virtual memory so that users will always know what changes have been made to their candidate's profile and the reasons that led him or her to vote for one or another candidate; educate users on election law and how the executive and legislative powers work at different levels; help candidates promote their profiles based on an analytical check of the areas of the map where they have a more or less higher concentration of voters; Identify all companies supporting this project through certification seals and all candidates with significant system and user approval and further by being made up of at least the following modules: Home, Institutional, and Candidate Profile; Candidate registration—security, candidate's area, news, articles—books, public services, certification seal, terms of use, comments, front end, algorithm assessment of the system, user registration, user panel, receipt of candidate and user contributions, interaction with Facebook® and other social networks, contact, shopping page, voting on bills, and distance learning course—video classes.

2. INFORMATION MANAGEMENT AND ASSESSMENT SYSTEM FOR POLITICAL AND OTHER TYPES OF CANDIDATES, as per claim 1, characterized by the fact that when a false profile or low level of discussion is detected, its creator will be penalized by the suspension or removal of the profile and further by means of a complaint filed with the Federal Police, Public Prosecutor's Office, and Superior Electoral Court, as the case may be.

3. INFORMATION MANAGEMENT AND ASSESSMENT SYSTEM FOR POLITICAL AND OTHER TYPES OF CANDIDATES, as per claim 1, characterized by fact that it includes filters to block the use of offensive and uncouth language.

4. INFORMATION MANAGEMENT AND ASSESSMENT SYSTEM FOR POLITICAL AND OTHER TYPES OF CANDIDATES, as per claim 1, characterized by fact that a space is provided for user's vote justification, which may or may not be shared so that in an upcoming election, how the candidate lives up to his or her campaign promises can be assessed and tracked.

5. INFORMATION MANAGEMENT AND ASSESSMENT SYSTEM FOR POLITICAL AND OTHER TYPES OF CANDIDATES, as per claim 1, characterized by the fact that the Home module has filters for choosing the state, city, district, and region; and a video of the project through a map of the country object of this invention, with a filter for defining each state, as well as Area of Action, Candidate, Resumes, Assessment of candidates by the System's Algorithm, Declared Assets, Parties, Number of Companies/Areas, and International Experience.

6. INFORMATION MANAGEMENT AND ASSESSMENT SYSTEM FOR POLITICAL AND OTHER TYPES OF CANDIDATES, as per claim 1, characterized by the fact that the candidate profile module has at least the following sections: video, questions, list of intentions to vote, assessment of the candidate or his/her actions, monitoring, and statistical data.

7. INFORMATION MANAGEMENT AND ASSESSMENT SYSTEM FOR POLITICAL AND OTHER TYPES OF CANDIDATES, as per claim 1, characterized by the fact that the candidate area module is a restricted area where, after registration has been activated, access will be allowed to his or her information, made available according to the rules set up by the portal, through which materials may be sent regarding the candidate's merits and resume.

8. INFORMATION MANAGEMENT AND ASSESSMENT SYSTEM FOR POLITICAL AND OTHER TYPES OF CANDIDATES, as per claim 1, characterized by the fact that the public service module is an orientation tool for those who are in public office as to how to proceed in certain issues. Draft bills and step-by-step guidelines for carrying out, but no limited to, bidding processes and bidding documents.

9. INFORMATION MANAGEMENT AND ASSESSMENT SYSTEM FOR POLITICAL AND OTHER TYPES OF CANDIDATES, as per claim 1, characterized by fact the that the assessment by the system's algorithm module provides the results of the assessment by calculations on the submission of merits and resumes by the candidate.

10. INFORMATION MANAGEMENT AND ASSESSMENT SYSTEM FOR POLITICAL AND OTHER TYPES OF CANDIDATES, as per claim 1, characterized by the fact that the receipt of candidate and user contributions module is a portal with receipt option through PayPal, Pagseguro, credit cards, and other similar methods that will have the amounts defined by the individual or legal entity registered in the Portal Administration, with such amounts being donated freely and spontaneously.

11. INFORMATION MANAGEMENT AND ASSESSMENT SYSTEM FOR POLITICAL AND OTHER TYPES OF CANDIDATES, as per claim 1, characterized by the fact that the shopping page module provides an integrated virtual store where products will be registered by portal administration and made available for purchase through credit cards or other similar methods in separate accounts.

12. INFORMATION MANAGEMENT AND ASSESSMENT SYSTEM FOR POLITICAL AND OTHER TYPES OF CANDIDATES, as per claim 1, characterized by the fact that the voting on bills module provides a list of bills with text and photos where each bill will have a vote button and users may register their votes by entering their ID number.

13. INFORMATION MANAGEMENT AND ASSESSMENT SYSTEM FOR POLITICAL AND OTHER TYPES OF CANDIDATES, as per claim 1, characterized by the fact that the distance learning—video classes course module provides video lessons and online course materials where the user accesses, watches the video classes, and downloads the materials.

14. INFORMATION MANAGEMENT AND ASSESSMENT SYSTEM FOR POLITICAL AND OTHER TYPES OF CANDIDATES, as per claim 1, characterized by fact that it includes additional functions such as limiting the number of voters for each city by having the system record and calculate the maximum number of votes in each city, therefore completely automating the registered number of intentions to vote in each region, plus a link for complaints, support to the manager, providing an electoral code, and a virtual election with users' votes handled confidentially.

15. INFORMATION MANAGEMENT AND ASSESSMENT SYSTEM FOR POLITICAL AND OTHER TYPES OF CANDIDATES, as per claim 1, characterized by the fact that it offers a discussion forum that narrows voter access to the candidate and allows discussion of socially relevant topics between the voter and his or her potential representative.

16. INFORMATION MANAGEMENT AND ASSESSMENT SYSTEM FOR POLITICAL AND OTHER TYPES OF CANDIDATES, as per claim 1, characterized by the fact that the user creates a virtual memory to better direct the vote and follow the candidates and their profiles, as well as fulfillment of their campaign promises.
